(19) United States
(12) Patent Application Publication
(10) Pub. No.: US 2016/0000157 A1
(43) Pub. Date: Jan. 7, 2016

(54) Youth Body Armor Device

(71) Applicant: Aaron Tzamarot, Scarsdale, NY (US)

(72) Inventor: Aaron Tzamarot, Scarsdale, NY (US)

(21) Appl. No.: 14/322,984

(22) Filed: Jul. 3, 2014

(51) Int. Cl. A41D 13/015; H04W 4/02; A42B 1/04; A41D 11/00; A41D 13/00

(52) U.S. Cl. CPC A41D 13/015; A41D 11/00; A41D 13/0012; A42B 1/04; H04W 4/02

(57) ABSTRACT

A youth body armor device protects a wearer from being damaged by ballistic and stabbing weapons. The device includes an article of clothing configured for being worn by a user. The article is constructed from a plurality of layers of ballistic and piercing resistant material. A plurality of plates is provided. Each of the plates is interposed between the layers of the ballistic resistant material. Each plate disperses force from a projectile over an enlarged area. A tracking chip is coupled to the article of clothing wherein a location of the article of clothing is determinable.

### BACKGROUND OF THE DISCLOSURE

### Field of the Disclosure

The disclosure relates to armor devices and more particularly pertains to a new armor device for protecting a youth wearer from being damaged by ballistic and stabbing weapons.

### SUMMARY OF THE DISCLOSURE

An embodiment of the disclosure meets the needs presented above by generally comprising an article of clothing configured for being worn by a user. The article is constructed from a plurality of layers of ballistic and piercing resistant material. A plurality of plates is provided. Each of the plates is interposed between the layers of the ballistic resistant material. Each plate disperses force from a projectile over an enlarged area. A tracking chip is coupled to the article of clothing wherein a location of the article of clothing is determinable.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a youth body armor device according to an embodiment of the disclosure.

FIG. 2 is a top back side perspective view of an embodiment of the disclosure.

FIG. 3 is a detailed perspective view of an embodiment of the disclosure.

FIG. 4 is a detailed perspective view of an embodiment of the disclosure in use.

FIG. 5 is a back view of an embodiment of the disclosure.

FIG. 6 is a cross-sectional view of an embodiment of the disclosure taken along line 6-6 of FIG. 1.

### DESCRIPTION OF THE PREFERRED EMBODIMENT

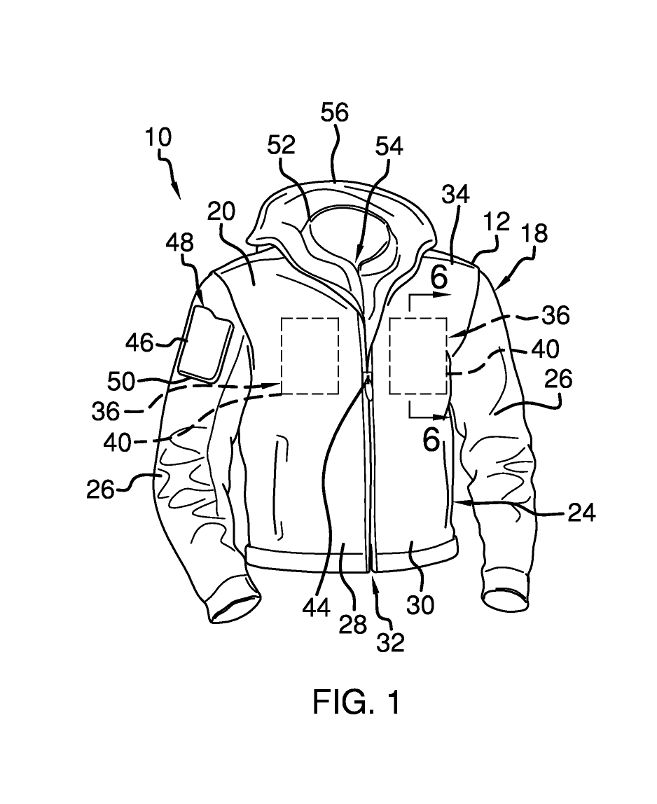

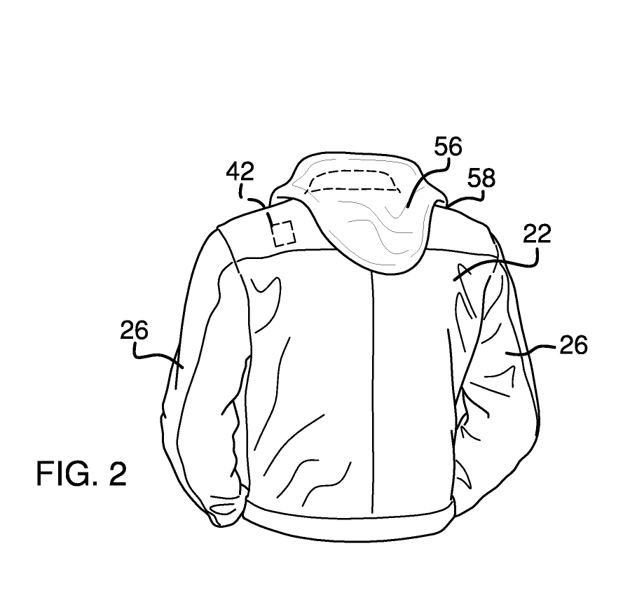

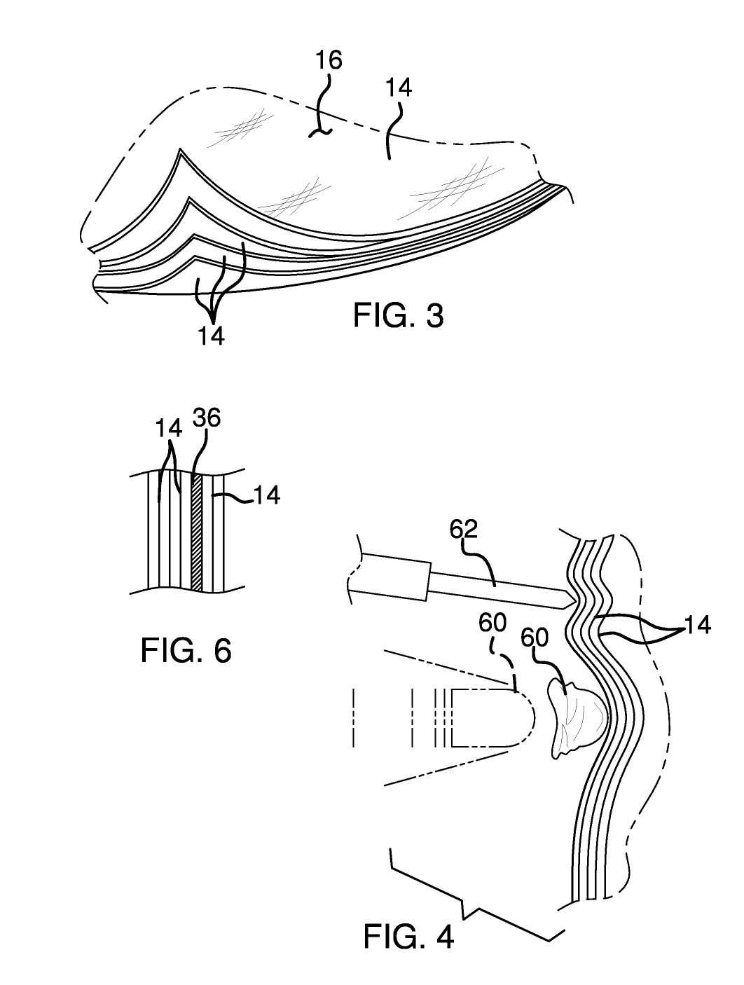

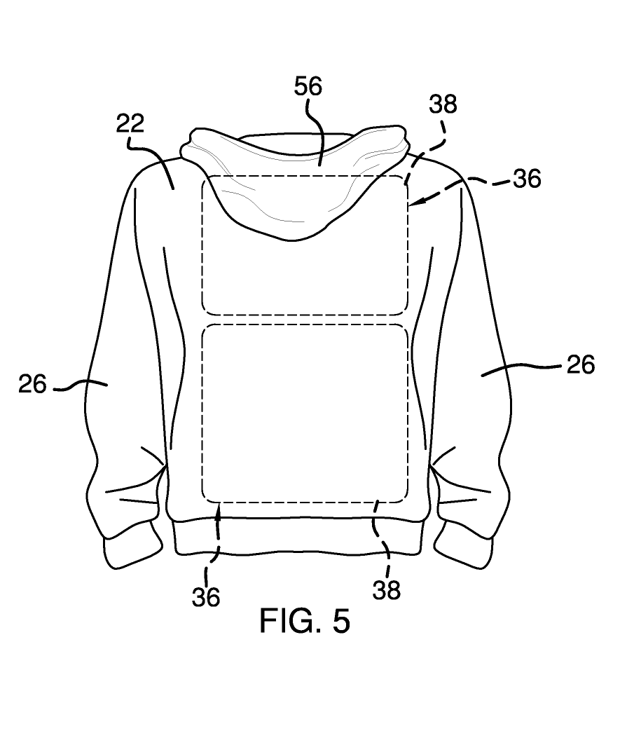

With reference now to the drawings, and in particular to FIGS. 1 through 6 thereof, a new armor device embodying the principles and concepts of an embodiment of the disclosure and generally designated by the reference numeral 10 will be described.

As best illustrated in FIGS. 1 through 6, the youth body armor device 10 generally comprises an article of clothing 12 configured for being worn by a user. The article 12 is constructed from a plurality of layers 14 of ballistic resistant material 16. The ballistic resistant material 16 may comprise aramid fibers or the like. The article of clothing 12 may be a jacket 18 having a front panel 20 and a back panel 22 defining a torso 24. The jacket 18 further comprises a pair of arms 26 coupled to and extending from the torso 24. The front panel 20 has a first section 28 and a second section 30 separated by a slit 32 wherein a front 34 of the torso 24 of the jacket 18 is openable. The jacket 18 may be either waterproof or water-resistant.

A plurality of plates 36 is provided. Each of the plates 36 is interposed between the layers 14 of the ballistic resistant material 16. Each plate 36 is designed to disperse and spread blunt force over an enlarged area enhancing protection from projectiles such as bullets. The plates 36 further spread force over the body greater than the ballistic resistant material 16 alone. Thus, the device 10 provides protection for smaller persons such as children who might otherwise be unable to withstand the force exerted on the person wearing the ballistic resistant material 16 alone. Each of the plates 36 may be constructed of a conventional ballistic impervious material which is flexible. The plurality of plates 36 comprises a pair of back plates 38. Each of the back plates 38 is positioned in the back panel 22 of the jacket 18. The plurality of plates 36 further comprises a pair of front plates 40. Each of the front plates 40 is positioned in a respective one of the first section 28 of the front panel 20 and the second section 30 of the front panel 20.

A tracking chip 42 is coupled to the article of clothing 12 wherein a location of the article of clothing 12 is determinable. A fastener 44, such as a zipper, snaps or the like, is coupled to the front panel 20. The fastener 44 selectively couples the first section 28 of the front panel 20 to the second section 30 of the front panel 20. A pocket 46 is coupled to one of the arms 26 of the jacket 18. The pocket 46 has an open top 48 and a closed bottom 50 wherein the pocket 46 is configured for holding a phone inserted into the pocket 46.

A neck panel 52 is coupled to and extends upwardly from the torso 24. The neck panel 52 has a front opening 54 aligned with the slit 32. The neck panel 52 is configured for extending around a neck of a person wearing the jacket 18. A hood 56 is coupled to and extends from the jacket 18. The hood 56 has a bottom edge 58 coupled to the torso 24. The bottom edge 58 of the hood 56 is coupled to the torso 24 in outwardly spaced relationship to the neck panel 52 wherein the neck panel 52 is positioned within the hood 56. The hood 56 is similarly comprised of a plurality of layers 14 of ballistic resistant material 16 to protect each side and a back of a head of a wearer while the hood 56 is worn by the wearer. The hood 56 may be removable from the torso 24 in a conventional manner.

In use, as stated above and shown in the Figures, a person wears the jacket 18 in a conventional manner. However, the ballistic resistant material 16 prevents penetration of a bullet 60 or stabbing weapon 62 through the jacket 18 and the hood 56 of the jacket 18. The plates 36 disperse force over an enlarged area to further protect the wearer of the jacket 18 from blunt force trauma caused by the projectile 60. The tracking chip 42 helps to determine a location of the person when the jacket 18 is being worn by the person. In this manner, the jacket 12 helps to protect a wearer in the event of a shooting, stabbing or kidnapping.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A youth body armor device comprising:
an article of clothing configured for being worn by a user, said article being constructed from a plurality of layers of ballistic resistant material;
a plurality of plates, each of said plates being interposed between said layers of said ballistic resistant material, each said plate being configured to disperse force from a projectile over an enlarged area; and
a tracking chip coupled to said article of clothing wherein a location of said article of clothing is determinable.

2. The device of claim 1, further comprising said article of clothing being a jacket having a front panel and a back panel defining a torso, said jacket further comprising a pair of arms coupled to and extending from said torso, said plurality of plates comprising a pair of back plates, each of said back plates being positioned in said back panel of said jacket.

3. The device of claim 2, further comprising:
said front panel having a first section and a second section separated by a slit wherein a front of said torso of said jacket is openable; and
a fastener coupled to said front panel, said fastener selectively coupling said first section of said front panel to said second section of said front panel.

4. The device of claim 3, further comprising said plurality of plates further comprising a pair of front plates, each of said front plates being positioned in a respective one of said first section of said front panel and said second section of said front panel.

5. The device of claim 2, further comprising a hood coupled to and extending from said jacket.

6. The device of claim 1, further comprising said ballistic resistant material comprising aramid fibers.

7. The device of claim 2, further comprising a pocket coupled to one of said arms of said jacket, said pocket having an open top and a closed bottom wherein said pocket is configured for holding a phone inserted into said pocket.

8. The device of claim 2, further comprising a neck panel coupled to and extending upwardly from said torso, said neck panel having a front opening aligned with said slit, said neck panel being configured for extending around a neck of a person wearing said jacket.

9. The device of claim 8, further comprising a hood coupled to and extending from said jacket, said hood having a bottom edge coupled to said torso, said bottom edge of said hood being coupled to said torso in outwardly spaced relationship to said neck panel wherein said neck panel is positioned within said hood.

10. A youth body armor device comprising:
an article of clothing configured for being worn by a user, said article being constructed from a plurality of layers of ballistic resistant material, said ballistic resistant material comprising aramid fibers, said article of clothing being a jacket having a front panel and a back panel defining a torso, said jacket further comprising a pair of arms coupled to and extending from said torso, said front panel having a first section and a second section separated by a slit wherein a front of said torso of said jacket is openable
a plurality of plates, each of said plates being interposed between said layers of said ballistic resistant material, each said plate being configured to disperse force from a projectile over an enlarged area, said plurality of plates comprising a pair of back plates, each of said back plates being positioned in said back panel of said jacket, said plurality of plates further comprising a pair of front plates, each of said front plates being positioned in a respective one of said first section of said front panel and said second section of said front panel;
a tracking chip coupled to said article of clothing wherein a location of said article of clothing is determinable;
a fastener coupled to said front panel, said fastener selectively coupling said first section of said front panel to said second section of said front panel;
a pocket coupled to one of said arms of said jacket, said pocket having an open top and a closed bottom wherein said pocket is configured for holding a phone inserted into said pocket;
a neck panel coupled to and extending upwardly from said torso, said neck panel having a front opening aligned with said slit, said neck panel being configured for extending around a neck of a person wearing said jacket; and
a hood coupled to and extending from said jacket, said hood having a bottom edge coupled to said torso, said bottom edge of said hood being coupled to said torso in outwardly spaced relationship to said neck panel wherein said neck panel is positioned within said hood.
